(19) United States
(12) Patent Application Publication
(10) Pub. No.: US 2013/0233184 A1
(43) Pub. Date: Sep. 12, 2013

(54) GREASE STRAINING DEVICE

(71) Applicant: David Scarlata, Keizer, OR (US)

(72) Inventor: David Scarlata, Keizer, OR (US)

(21) Appl. No.: 13/413,496

(22) Filed: Mar. 6, 2012

(51) Int. Cl. A47J 36/08

(52) U.S. Cl. 99/444

(57) ABSTRACT

The present invention is a grease straining device utilized in combination with a frying pan with an edge that includes a pan connector that curves around along the frying pan edge and partially extends over the frying pan, a rectangular planar shaped divider and strainer that is attached to the pan connector that extends downward into the frying pan and allows grease and oil from food cooked in the frying pan to be safely poured off of and out of the frying pan and a strainer handle that extends perpendicularly upward from the pan connector to allow a user to grasp the grease straining device while being utilized in combination with said frying pan. There is also an optional a splatter screen attachment that is attached to the strainer that extends horizontally across the frying pan to provide additional protection from grease and oil splatters.

### TECHNICAL FIELD & BACKGROUND

Traditional methods of removing excess oil or grease from cooking equipment include utilizing a pan lid as a strainer for a frying pan. This conventional approach may be difficult and cumbersome and may cause the excess oil or grease to splatter, or the food being prepared to slip or fall out of the frying pan itself.

The present invention generally relates to a straining device. More specifically, the invention is a grease straining device.

It is an object of the invention to provide a grease straining device that serves as an attachment to allow a user to safely strain grease or oil from a frying pan.

It is an object of the invention to provide a grease straining device that utilizes a plurality of different sized attachments to accommodate a plurality of different sized frying pans to safely strain grease or oil from a frying pan.

It is an object of the invention to provide a grease straining device that allows a user to relatively quickly strain grease from a frying pan to allow the user to relatively quickly continue cooking if needed.

What is really needed is a grease straining device that serves as an attachment to allow a user to safely strain grease or oil from a frying pan that utilizes a plurality of different sized attachments to accommodate a plurality of different sized frying pans to safely strain grease or oil from a frying pan that allows a user to relatively quickly strain grease from a frying pan to allow the user to relatively quickly continue cooking if needed.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a top view of a grease straining device utilized in combination with a frying pan, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

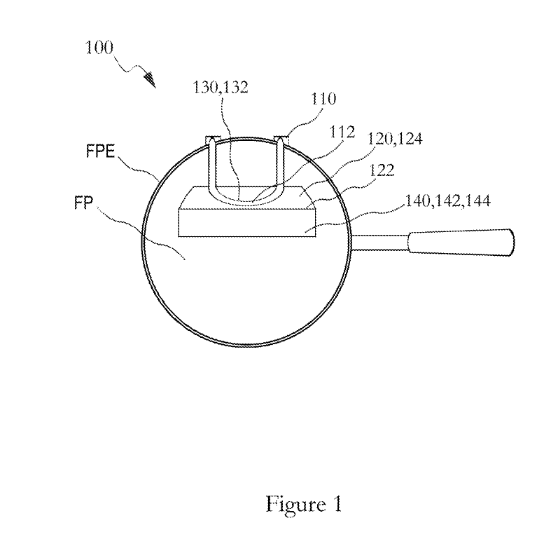

FIG. 1 illustrates a top view of a grease straining device 100 utilized in combination with a frying pan FP, according to an embodiment of the present invention.

The grease straining device 100 includes a pan connector 110, a divider and strainer 120, a strainer handle 130 and a splatter screen attachment 140. The pan connector 110 curves around any location along a frying pan edge FPE and partially extend over the frying pan FP at a distal end 112. The divider and strainer 120 has a top edge 122 and is rectangular planar shaped 124 and is attached to the distal end 112 of the pan connector 110, although the divider and strainer 120 can be any suitable shape such as a square shape or a semi-circular shape. The divider and strainer 120 extends downward into the frying pan FP and allows grease and oils from foods cooked in the frying pan FP to be safely poured off of and out of the frying pan FP while keeping the cooked food within the frying pan FP. The strainer handle 130 extends perpendicularly upward from the distal end 112 of the pan connector 110 to allow a user to grasp the grease straining device 100 while being utilized in combination with a frying pan. The strainer handle 130 is U-shaped 132 to be ergonomically designed but can be any suitable shape. The splatter screen attachment 140 is an optional rectangular planar attachment 142 that can be attached to the top edge 122 of the divider and strainer 120 that typically extends horizontally across the frying pan FP to provide additional protection from grease and oil splatters. The splatter screen attachment 140 is typically a screen 144 but can be any suitable protective attachment. The grease straining device 100 is made of a high temperature resistant plastic and silicone material but can be made of other suitable materials as well.

The grease straining device is an attachment that is a relatively superior alternative to similar traditional grease straining devices and methods. The grease straining device is fastened to the outside edge of the frying pan, allowing a divider and strainer to lay flush against the frying pan. The grease straining device is designed to be adaptable and capable of accepting separate attachments to accommodate a plurality of various existing frying pan diameters. The grease straining device is able to effectively eliminate spilled food and grease and oil splatters and may be readily available at retail department stores and wherever cookware is sold. The grease straining device features a divider and strainer packaged with a splatter screen attachment, offering improved protection while removing excess cooking grease and oil. The grease straining device is durable, easy to use and attach, effective, safe and is capable of accepting several included attachments.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A grease straining device utilized in combination with a frying pan with an edge, comprising:
a pan connector with a distal end that curves around along said frying pan edge and partially extends over said frying pan;
a divider and strainer with a top edge that is attached to said distal end of said pan connector that extends downward into said frying pan and allows grease and oil from food cooked in said frying pan to be safely poured off of and out of said frying pan while keeping said cooked food within said frying pan;
a strainer handle that extends upward from said distal end of said pan connector to allow a user to grasp said grease straining device while being utilized in combination with said frying pan; and
a splatter screen attachment that is attached to said top edge of said divider and strainer that extends horizontally across said frying pan to provide additional protection from grease and oil splatters.

2. The device according to claim 1, wherein said pan connector is connected anywhere along said frying pan edge.

3. The device according to claim 1, wherein said divider and strainer is rectangular planar shaped.

4. The device according to claim 1, wherein said strainer handle is perpendicularly extended upward.

5. The device according to claim 1, wherein said strainer handle is u-shaped.

6. The device according to claim 1, wherein said splatter screen attachment is optionally attached.

7. A grease straining device utilized in combination with a frying pan with an edge, comprising:
a pan connector with a distal end that curves around along said frying pan edge and partially extends over said frying pan;
a rectangular planar shaped divider and strainer with a top edge that is attached to said distal end of said pan connector that extends downward into said frying pan and allows grease and oil from food cooked in said frying pan to be safely poured off of and out of said frying pan while keeping said cooked food within said frying pan;
a strainer handle that extends upward from said distal end of said pan connector to allow a user to grasp said grease straining device while being utilized in combination with said frying pan; and
a splatter screen attachment that is attached to said top edge of said divider and strainer that extends horizontally across said frying pan to provide additional protection from grease and oil splatters.

8. The device according to claim 7, wherein said pan connector is connected anywhere along said frying pan edge.

9. The device according to claim 7, wherein said strainer handle is perpendicularly extended upward.

10. The device according to claim 7, wherein said strainer handle is u-shaped.

11. The device according to claim 7, wherein said splatter screen attachment is optionally attached.

12. The device according to claim 7, wherein said grease straining device is made of a high temperature resistant plastic and silicone material.

13. A grease straining device utilized in combination with a frying pan with an edge, comprising:
a pan connector with a distal end that curves around along said frying pan edge and partially extends over said frying pan;
a rectangular planar shaped divider and strainer with a top edge that is attached to said distal end of said pan connector that extends downward into said frying pan and allows grease and oil from food cooked in said frying pan to be safely poured off of and out of said frying pan while keeping said cooked food within said frying pan;
a strainer handle that extends perpendicularly upward from said distal end of said pan connector to allow a user to grasp said grease straining device while being utilized in combination with said frying pan; and
a splatter screen attachment that is attached to said top edge of said divider and strainer that extends horizontally across said frying pan to provide additional protection from grease and oil splatters.

14. The device according to claim 13, wherein said pan connector is connected anywhere along said frying pan edge.

15. The device according to claim 13, wherein said strainer handle is u-shaped.

16. The device according to claim 13, wherein said strainer handle is ergonomically designed.

17. The device according to claim 13, wherein said splatter screen attachment is optionally attached.

18. The device according to claim 13, wherein said splatter screen attachment is a rectangular planar attachment.

19. The device according to claim 13, wherein said splatter screen attachment is a screen.

20. The device according to claim 13, wherein said grease straining device is made of a high temperature resistant plastic and silicone material.
